(19) United States
(12) Patent Application Publication
(10) Pub. No.: US 2022/0199992 A1
(43) Pub. Date: Jun. 23, 2022

(54) CATHODE MATERIAL, CATHODE INCLUDING THE SAME, AND LITHIUM-AIR BATTERY INCLUDING THE CATHODE

(71) Applicant: SAMSUNG ELECTRONICS CO., LTD., Suwon-si (KR)

(72) Inventors: Mokwon Kim, Suwon-si (KR); Sangbok Ma, Suwon-si (KR); Jungock Park, Yongin-si (KR)

(21) Appl. No.: 17/396,839

(22) Filed: Aug. 9, 2021

(30) Foreign Application Priority Data
Dec. 21, 2020 (KR) 10-2020-0179930

(51) Int. Cl. H01M 4/525; H01M 4/131; H01M 12/08; H01M 4/505; H01M 4/38; H01M 4/04

(52) U.S. Cl. CPC H01M 4/525; H01M 4/131; H01M 12/08; H01M 4/485; H01M 4/382; H01M 4/0457; H01M 4/0407; H01M 4/505

(57) ABSTRACT

A cathode material, a cathode including the same, a method of manufacturing the cathode, and a lithium-air battery including the cathode, the cathode material configured to use water and oxygen as a cathode active material, the cathode material including a metal oxide represented by Formula 1:

MₓO_{y} Formula 1

wherein, in Formula 1, M is Ti, Cu, Co, Ce, Cu, Fe, Eu, Cd, Co, Cr, Mn, Mo, Nb, Pu, Ru, Tc, U, V, Ir, or a combination thereof, 0<x≤20, 0<y≤34, and 0.05<y/x<10, with the proviso that when M is Mn, 0.05<y/x≤1.4, wherein the cathode material has a phase stability value of about 1.2 electronvolts or less at a pH of 12 to 14 and at a voltage of 2 to 4.5 volts with respect to lithium metal, and a bandgap energy of 0 electronvolts when determined by density functional theory.

### CROSS-REFERENCE TO RELATED APPLICATION

This application claims priority to and the benefit of Korean Patent Application No. 10-2020-0179930, filed on Dec. 21, 2020, in the Korean Intellectual Property Office, and all the benefits accruing therefrom under 35 U.S.C. § 119, the content of which in its entirety is herein incorporated by reference.

### BACKGROUND

### 1. Field

The present disclosure relates to a cathode material, a cathode including the same, and a lithium-air battery including the cathode.

### 2. Description of the Related Art

A lithium-air battery uses lithium as the anode active material and it is unnecessary to store air as a cathode active material in the battery, and thus, a lithium-air battery may be implemented as a high-capacity battery. In addition, lithium-air batteries have a high theoretical specific energy of about 3,500 watt-hour per kilogram (Wh/kg) or greater.

When oxygen is used as a cathode active material in a lithium-air battery, a voltage of about 3 volts (V) is generated during operation, whereas when gas including moisture (or water) and oxygen is used as a cathode active material, a voltage of about 4.5 V is generated during operation of the battery. Accordingly, a gas including moisture and oxygen may be used as a cathode active material.

However, when gas a including moisture and oxygen is used as the cathode active material, lithium hydroxide (LiOH), which is a strong base, is generated as a discharge product from a discharge reaction, and organic cathode materials such as carbonaceous cathode materials may be decomposed by the strong basic material. Therefore, there remains a need for an improved cathode material.

### SUMMARY

Provided is a cathode material that is stable under condition of using moisture.

Provided is a cathode including the cathode material.

Provided is a lithium-air battery including the cathode.

Provided is a method of manufacturing the cathode.

Additional aspects will be set forth in part in the description which follows and, in part, will be apparent from the description, or may be learned by practice of the presented embodiments of the disclosure.

According to an embodiment, there is provided
a cathode material configured to use water and oxygen as a cathode active material,
the cathode material including a metal oxide represented by Formula 1:

MₓO_{y} Formula 1

wherein, in Formula 1, M is Ti, Cu, Co, Ce, Cu, Fe, Eu, Cd, Co, Cr, Mn, Mo, Nb, Pu, Ru, Tc, U, V, Ir, or a combination thereof, 0<x≤20, 0<y≤34, and 0.05<y/x<10,
with the proviso that when M is Mn, 0.05<y/x≤1.4,
wherein the cathode material has a phase stability value of about 1.2 electronvolts or less at a pH of 12 to 14 and at a voltage of 2 to 4.5 volts with respect to lithium metal, and a bandgap energy of 0 electronvolts when determined by density functional theory.

According to an embodiment, there is provided a cathode including the disclosed cathode material. According to an embodiment, provided is a lithium-air battery comprising: the cathode;
an anode including lithium; and
an electrolyte disposed between the cathode and the anode.

According to an embodiment, there is provided a lithium-air battery comprising: a cathode configured to use water and oxygen as a cathode active material and including the disclosed cathode material;
an anode; and
an electrolyte disposed between the cathode and the anode.

According to an embodiment, there is provided a method of manufacturing a cathode, the method comprising: providing a suspension including the disclosed cathode material; and
depositing the cathode active material on a porous framework substrate by electrophoresis.

According to an embodiment, there is provided a lithium-air battery, comprising:
a cathode comprising
a porous framework substrate having a porosity of about 70 to about 99%, and
Ti₂O₃, CuO, Ce₁₇O₃₂, Fe₃O₄, Eu₂O₃, Eu₃O₄, or Co₃O₄ having a particle size of about 10 to about 500 nanometers and disposed on the porous framework substrate;
an anode comprising lithium; and
a lithium aluminum titanium phosphate solid electrolyte between the cathode and the anode.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1 and 2 are optical microscope images of opposite surfaces of a cathode of a lithium-air battery manufactured in Manufacturing Example 1, respectively;

FIG. 3 is a graph of absorbance (arbitrary units (a.u.)) versus wave number (inverse centimeters (cm⁻¹)) showing an infrared (“IR”) spectrum of a cathode material used in Manufacturing Example 1;

FIG. 4 is a graph of voltage (volts (V)) versus Li/Li⁺)) versus capacity (milliampere-hours per square centimeter (mAh/cm²)) showing charge-discharge profiles of lithium-air batteries of Manufacturing Example 1 and Comparative Manufacturing Example 1;

FIG. 5 is a graph of intensity (a.u.) versus diffraction angle (degrees 2θ) showing an X-ray diffraction spectrum of a discharge product in a cathode of Manufacturing Example 1 using Cu-Kα radiation;

FIG. 6 is a schematic view showing a structure of an embodiment of a lithium-air battery; and

FIG. 7 is an electron scanning microscope image showing a fibrous framework of an embodiment of a porous framework substrate.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present disclosure will now be described more fully with reference to the accompanying drawings, in which example embodiments are shown. The present disclosure may, however, be embodied in many different forms, should not be construed as being limited to the embodiments set forth herein, and should be construed as including all modifications, equivalents, and alternatives within the scope of the present disclosure.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprise,” “include,” and/or “have,” when used in this specification, specify the presence of stated features, integers, steps, operations, elements, and/or components, but do not preclude the presence or addition of one or more other features, integers, steps, operations, elements, components, and/or groups thereof. As used herein, the slash “/” or the term “and/or” includes any and all combinations of one or more of the associated listed items.

In the drawings, the size or thickness of each layer, region, or element are arbitrarily exaggerated or reduced for better understanding or ease of description, and thus the present disclosure is not limited thereto. Throughout the written description and drawings, like reference numbers and labels will be used to denote like or similar elements. It will also be understood that when an element such as a layer, a film, a region or a component is referred to as being “on” another layer or element, it can be “directly on” the other layer or element, or intervening layers, regions, or components may also be present. Although the terms “first”, “second”, etc., may be used herein to describe various elements, components, regions, and/or layers, these elements, components, regions, and/or layers should not be limited by these terms. These terms are used only to distinguish one component from another, not for purposes of limitation.

Furthermore, relative terms, such as “lower” and “upper,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, a C-rate means a current which will discharge a battery in one hour, e.g., a C-rate for a battery having a discharge capacity of 1.6 ampere-hours would be 1.6 amperes.

Hereinafter, an embodiment of a cathode material, a cathode including the same, a method of manufacturing the cathode, and a lithium-air battery will be described in greater detail.

According to an embodiment, provided is a cathode material configured to use water and oxygen as a cathode active material, the cathode material having a phase stability value of about 1.2 electronvolts (eV) or less at a pH of about 12 to about 14 at a voltage of about 2 to about 4.5 V with respect to lithium metal, and having a bandgap energy of 0 eV as measured by first-principles electronic structure calculation method based on a density functional theory (“DFT”) calculation, and including a metal oxide represented by Formula 1.

MₓO_{y} Formula 1

wherein, in Formula 1, M is Ti, Cu, Co, Ce, Cu, Fe, Eu, Cd, Co, Cr, Mn, Mo, Nb, Pu, Ru, Tc, U, V, Ir, or a combination thereof, x>0, and y>0.

In Formula 1, 1≤x≤20, for example, 1≤x≤17; 1≤y≤34, for example, 1≤y≤32; and 0.05<y/x<10, 0.08<y/x<8, 0.09<y/x<7, 0.1<y/x<5, 0.1<y/x<4, 0.1<y/x<3, 0.5<y/x<2.5, 0.5<y/x<2, or 1<y/x<2.

In Formula 1, when M is Mn, 0.05<y/x≤1.4, 0.05<y/x≤1.2, 0.08<y/x≤1.1, 0.09<y/x≤1.1, 0.1<y/x≤1, 0.3<y/x≤1, 0.5<y/x≤1, 0.7<y/x≤1, or 0.8<y/x≤1.

A lithium-air battery may use oxygen as a cathode active material, and thus, Li₂O₂ may be produced as a discharge product on the cathode surface during discharging.

A lithium-air battery including a cathode according to an embodiment is configured to use moisture (also referred to herein as water or water vapor) and oxygen as a cathode active material, and thus, LiOH is produced as a discharge product on the cathode surface during discharge, according to the following reaction scheme.

4Li⁺+4e⁻+O₂+2H₂O→4LiOH Reaction Scheme

During discharge of the lithium-air battery, the lithium anode active material is decomposed into lithium ions and electrons, the lithium ions are transferred to the cathode surface through a solid electrolyte, and the electrons are transferred from the lithium anode to the cathode surface. At this time, the oxygen and moisture present on the cathode surface react with the lithium ions and electrons to produce lithium hydroxide (LiOH) as a reaction product.

LiOH is an alkali hydroxide and is strongly basic, and it is desirable to use a cathode material that does not deteriorate when contacted with a strong base. However, in an existing lithium-air battery, porous carbon or Ru-based metal is used as a cathode material, and these materials deteriorate under strong basic conditions.

Accordingly, the present inventors have surprisingly found a cathode material that is electrochemically stable even under strong basic conditions, and a cathode including the same.

The present inventors have surprisingly found that the disclosed cathode material is not only electrochemically stable under strong basic conditions, but also has improved moisture stability, and structural and chemical stability in a voltage of 2 V to 4.5 V versus Li/Li⁺, which is a charge and discharge voltage range of a lithium-air battery, and accordingly, have applied this cathode material as a cathode.

The metal oxide of Formula 1 has a particle size of about 1 to about 15 micrometers (μm), about 5 to about 12 μm, about 8 to about 11 μm, or about 10 μm. This metal oxide may be selected to have a size of, for example, about 10 to about 500 nanometers (nm), about 50 to about 450 nm, or about 100 to about 400 nm by a grinding process.

As used herein, the particle size indicates the average particle diameter when particles are spherical. Herein, the particle size indicates the average particle diameter when particles are spherical, and the length of the major axis when particles are non-spherical. The particle size may be identified through electron scanning microscopy. In an aspect the particle size is a D₅₀ particle size.

When the metal oxide of Formula 1 has the disclosed crystal structure and size, the metal oxide is suitably inert with respect to a discharge product having a pH of about 9 or greater, pH of about 10 or greater, pH of about 11 or greater, and pH of about 12 or greater, for example, pH of about 12 to about 14, and thus is structurally, chemically, and electrochemically stable. The discharge product includes lithium hydroxide produced by reaction of lithium ions and moisture.

The range of pH 12 to pH 14 is a pH range of an aqueous solution in which LiOH is dissolved, and may mean a pH environment formed by a discharge product generated in a lithium-air battery configured to use a gas containing moisture and oxygen, e.g., air, as a cathode active material.

The metal oxide of Formula 1 may be a binary compound and have a phase stability value of about 1.2 eV or less, about 0 to about 0.5 eV, or about 0.0001 to about 0.5 eV at a voltage of about 2 to about 4.5 V with respect to lithium metal (versus Li/Li⁺) in an environment of pH of about 12 to about 14 and thus is electrochemically stable. When the phase stability value is 0, it means that the cathode material is suitably stable in a strong base, and reduction does not occur even under reducing conditions (low voltage, about 2 V, a discharging lower limit) and oxidation does not occur under oxidation conditions (high voltage, about 4.5 V, a charging upper limit).

The cathode material having a phase stability value within the disclosed ranges is structurally and chemically stable in a predetermined pH environment and at the disclosed charging/discharging voltages, and a lithium-air battery including the same may have a long lifespan due to improved durability of the cathode, and may have high output characteristics because moisture is used as a cathode active material.

The phase stability value is evaluated using a quantum calculation-based Pourbaix Diagram and a phase stability calculation platform and examining a difference in energy between the most stable material and a test material. The phase stability value evaluation method using the Pourbaix diagram is a method disclosed in A. M. Patel et al., Phys. Chem. Chem. Phys., 2019, 21, 25323, which is incorporated herein in its entirety by reference. According to this evaluation method, derived is a cathode material having the amount of change in the Gibbs free energy value (ΔG) of 0 eV under the conditions of pH of about 12 to about 14 and a voltage of about 2 to about 4.5 V.

The evaluation method will be described in more detail as follows.

The amount of change in the Gibbs free energy (ΔG) of a test material (hereinafter referred to as material A) is derived from the potential-pH diagram (“E-pH diagram”) of material A obtained by a quantum calculation. The change in the Gibbs energy value is also referred to as phase stability or decomposition energy. In addition, the potential-pH diagram is also referred to as a Pourbaix diagram after the name of its inventor.

A method of plotting the potential-pH diagram follows a method disclosed in M. Pourbaix, Atlas of Electrochemical Equilibria in Aqueous Solutions, 1966. In addition, the energy values of a material for plotting the potential-pH diagram may be obtained using a quantum calculation method, such as first principles calculation or Density Functional Theory. Additional details for the calculation can be determined by one of skill in the art without undue experimentation.

A phase stability value of material A at a certain voltage and pH is calculated as an energy value at which material A is decomposed into material B, which is the most stable under that condition, that is, the amount of change in the Gibbs free energy (ΔG).

For example, if the most stable material under the conditions of about 3.5 V and pH of about 12 is material B, the phase stability value of material A is the amount of change in the Gibbs free energy (ΔG) at which material A is decomposed into material B.

For example, if the most stable material under the conditions of about 3.5 V and pH of about 12 is material A, the phase stability value of material A is the energy at which material A is decomposed into material A, and thus is zero.

The method of evaluating the phase stability of a material at a given voltage and pH condition is further disclosed in A. M. Patel et al., Phys. Chem. Chem. Phys., 2019, 21, 25323. According to this evaluation method, when material A has the amount of change in the Gibbs free energy (ΔG) of 0 eV in the entire pH range of about 12 to about 14 and a voltage condition of about 2 to about 4.5 V, material A is defined to be “stable” under the disclosed pH and voltage condition (i.e., not decomposed and the phase stability value is 0 eV), and this material A is derived as a cathode material.

The amount of change in the Gibbs free energy (ΔG) of the metal oxide of Formula 1 according to an embodiment may be 0 eV under a about 2 to about 4.5 V voltage condition. Accordingly, it is found that the cathode material is electrochemically stable during charge and discharge of a lithium-air battery, and a phase change would not be expected.

The cathode material according to an embodiment may have oxidation resistance and reduction resistance in the pH environment of pH of about 12 to about 14 at a voltage of about 2 to about 4.5 V with respect to lithium metal. As used herein, the term “oxidation resistance” means not involved in an oxidation reaction, and similarly, the term “reduction resistance” means not involved in a reduction reaction. Thus, the cathode material may have substantially no reactivity, for example, may be inert, in the disclosed pH environment, charging/discharging voltages, or a combination thereof. In other words, the cathode material is not involved in the oxidation and reduction of lithium and oxygen in the disclosed pH environment and charging/discharging voltage range.

The cathode material according to an embodiment may have a bandgap energy of 0 eV as measured by a theoretical calculation method in the framework of the density functional theory (“DFT”). When the bandgap energy is 0 eV, electron mobility is high and electron conductivity is excellent. The cathode material may have an electron conductivity of about 1.0×10⁻⁶ to about 100 siemens per centimeter (S/cm), for example, about 0.1 to about 100 S/cm.

The cathode material may have a lithium insertion voltage of about 2.5 V or less, for example, about 0.3 to about 2.4 V, as an estimated value obtained through a DFT calculation.

The cathode material may have an energy above hull of about 0.1 eV or less, about 0.095 eV or less, about 0.09 eV or less, about 0.085 eV or less, about 0.082 eV or less, for example about 0.0001 to about 0.082 eV.

Herein, the phase stability of the cathode material may be evaluated by calculation of the energy above hull thereof. The energy above hull may be calculated from the framework of the DFT using a Vienna ab initio simulation package (“VASP”). When the energy above hull is within the disclosed ranges, phase stability of the cathode material is improved.

In an embodiment, in Formula 1, 0.1≤y/x≤4, 1≤x≤20, and 1≤y≤34. For example, 1≤x≤17 and 1≤y≤32.

In an embodiment, in Formula 1, M is Ti, Cu, Co, Ce, Cu, Fe, Eu, or a combination thereof, and 1≤y/x≤3.

In an embodiment, in Formula 1, 0.5<y/x<2.5, 0.5≤y/x≤2.2, 0.8<y/x<2.3, 0.8<y/x<2.3, and 1≤y/x≤2.

The cathode material may be, for example, a metal oxide represented by Formulae 2 to 6.

TiₓO_{y} Formula 2
In Formula 2, 1≤y/x≤2.

CuₓO_{y} Formula 3
In Formula 3, 0.5≤y/x≤2.

CeₓO_{y} Formula 4
In Formula 4, 1≤y/x≤2.

FeOₓO_{y} Formula 5
In Formula 5, 1≤y/x≤2.

EuₓO_{y} Formula 6
In Formula 6, 1≤y/x≤2, or
a combination thereof.

In Formulae 2 to 6, 1≤x≤20 and 1≤y≤34, for example, 1≤x≤17 and 1≤y≤32.

The cathode material may be, for example, Ti₁₁O₁₈, Ti₁₃O₂₂, Ti₁₉O₃₀, Ti₂O₃, Ti₃O₅, Ti₄O₇, Ti₅O₈, Ti₅O₉, Ti₆O₁₁, Ti₇O₁₃, Ti₈O₁₅, Ti₉O₁₇, Ti₁₀O₁₈, Ti₁₃O₂₂, Ti₁₉O₃₀, CdO, Ce₁₃O₂₄, Ce₁₆O₂₇, Ce₁₇O₃₂, Ce₅O₉, Ce₇O₁₂, CoO, CrO, Cu₄O₃, Cu₈O₇, CuO, Eu₂O₃, Eu₃O₄, EuO, Fe₁₂O₁₃, Fe₃O₄, Fe₇O₈, FeO, IrO₂, MnO, MoO₂, Nb₁₂O₂₉, RuO₂, TcO₂, V₂O₃, or a combination thereof.

The cathode material according to an embodiment may be a crystalline lithium ion conductor, a crystalline electron conductor, or a mixed conductor. The cathode material may have an electronic conductivity at about 25° C. of about 1.0×10⁻⁶ S/cm or greater, for example, about 1.0×10⁻⁶ to about 100 S/cm or about 0.1 to about 100 S/cm.

The cathode material according to an embodiment may be applied to, e.g., used in, an all-solid state lithium-air battery with improved reversibility under a humidified environment. To this end, a solid electrolyte having good moisture barrier properties may be used as the electrolyte. Using such a solid electrolyte, reversibility is improved by exclusion of organic liquid electrolytes used in existing lithium-air batteries.

The disclosed solid electrolyte may be, for example, an oxide-based solid electrolyte.

The oxide-based solid electrolyte may be, for example, Li_{1+x+y}AlₓTi₂₋ₓSi_{y}P_{3-y}O₁₂ (wherein 0<x<2 and 0≤y<3), BaTiO₃, Pb(ZrₐTi₁₋ₐ)O₃ (“PZT”) (wherein 0≤a≤1), Pb₁₋ₓLaₓZr_{1-y}Ti_{y}O₃ (“PLZT”) (wherein 0≤x<1 and 0≤y<1), Pb(Mg_{1/3}Nb_{2/3})O₃—PbTiO₃ (“PMN-PT”), HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ (wherein 0<x<2 and 0<y<3), LiₓAl_{y}Ti_{z}(PO₄)₃ (wherein 0<x<2, 0<y<1, and 0<z<3), Li_{1+x+y}(AlₐGa₁₋ₐ)ₓ(Ti_{b}Ge_{1-b})₂₋ₓSi_{y}P_{3-y}O₁₂ (wherein 0≤a≤1, 0≤b≤1, 0≤x≤1, and 0≤y≤1), LiₓLa_{y}TiO₃ (wherein 0<x<2 and 0<y<3), Li₂O, LiOH, Li₂CO₃, LiAlO₂, Li₂O—Al₂O₃—SiO₂—P₂O₅—TiO₂—GeO₂, and Li₃₊ₓLa₃M₂O₁₂ (wherein M is Te, Nb, or Zr, and x is an integer from 1 to 10), or a combination thereof.

The solid electrolyte may be, for example, a Garnet-type solid electrolyte such as Li₇La₃Zr₂O₁₂ (“LLZO”) and Li₃₊ₓLa₃Zr₂₋ₐMₐO₁₂ (“M-doped LLZO”, wherein M is Ga, W, Nb, Ta, or Al, x is an integer from 1 to 10, and 0.05≤a≤0.7), or a combination thereof. Using such a solid electrolyte, a lithium-air battery with excellent performance may be manufactured.

The cathode material according to an embodiment is electrochemically stable in a pH environment of about 12 to about 14 at a voltage of about 2 to about 4.5 V with respect to a lithium anode, and thus enables a lithium-air battery configured to use water and oxygen as a cathode active material to be used for a long time.

According to an embodiment, the amount of the cathode material may be about 1 to about 100 parts by weight, with respect to 100 parts by weight of the cathode. For example, the amount of the cathode material may be about 10 to about 100 parts by weight, about 50 to about 100 parts by weight, about 60 to about 100 parts by weight, about 70 to about 100 parts by weight, about 80 to about 100 parts by weight, or about 90 to about 100 parts by weight, with respect to 100 parts by weight of the cathode. When the amount of the cathode material in the cathode is within the disclosed ranges, a cathode with desirable durability against a discharge product is obtained.

The cathode may further include a conductive material, a catalyst for oxidation/reduction of oxygen, a binder, or a combination thereof. The conductive material, the catalyst for oxidation/reduction of oxygen, and the binder will be further described herein.

According to an embodiment, the amount of the cathode material may be, with respect to 100 parts by weight of the total cathode, for example, about 1 to about 99 parts by weight, about 10 to about 98 parts by weight, about 10 to about 95 parts by weight, about 30 to about 95 parts by weight, about 50 to about 95 parts by weight, about 60 to about 95 parts by weight, about 70 to about 95 parts by weight, about 80 to about 95 parts by weight, or about 90 to about 95 parts by weight, with respect to 100 parts by weight of the total cathode.

The amount of the water in the gas may be, with respect to 100 parts by weight of oxygen in the gas, about 4 parts by weight or less, about 0.01 to about 4 parts by weight or less, about 1.5 to about 4 parts by weight, or about 1.5 to about 3 parts by weight. When the amount of water in the gas is within the disclosed ranges, a lithium-air battery configured to use water and oxygen as a cathode active material may generate a desirably high output.

According to an embodiment, a lithium-air battery includes: the cathode according to an embodiment; a lithium-containing anode; and an electrolyte disposed between the cathode and the anode.

By use of the cathode including the cathode material according to an embodiment, deterioration of the lithium-air battery may be reduced or suppressed and a high output may be achieved.

The lithium-air battery may include a cathode. The cathode is an air electrode, and air included in the air electrode is air containing moisture and oxygen. For example, the cathode is disposed on a cathode current collector.

The cathode is inert against a discharge product having a pH of about 9 or greater. For example, the cathode is inert against a discharge product under a pH environment of about 12 to about 14. Accordingly, in the lithium-air battery configured to use a gas containing water and oxygen, e.g., air, as the cathode active material, the cathode is structurally stable and may be suppressed from deteriorating, and thus has a long lifespan.

The discharge product may include LiOH produced by reaction of lithium ions and moisture (H₂O (gas)). Alkali hydroxides such as LiOH are strongly basic, and have a pH of about 12 to about 14 in an aqueous solution.

A cathode according to an embodiment is configured to use, for example, a porous framework substrate including the cathode material according to an embodiment. The porous framework substrate may have suitable electronic conductivity.

The cathode is configured to use oxygen as a cathode active material. The cathode includes: a porous framework substrate having electronic conductivity; and a coating layer arranged along a surface of the framework constituting the porous framework substrate, wherein the coating layer includes the cathode material according to an embodiment.

By the arrangement of the coating layer including the cathode material on the porous framework substrate, electrons migrating through the porous framework substrate and lithium ions migrating through the coating layer may contact one another over the entire cathode. Accordingly, the effective reaction area in which electrons and lithium ions react is significantly increased and a discharge product may be uniformly produced in the cathode. In addition, the cathode is porous, and thus the discharge product is produced mainly in the cathode. Accordingly, a volume change of the lithium-air battery is minimized, reversibility of the electrode reaction is improved to inhibit overvoltage, and consequently the lithium-air battery has improved cycle characteristics.

The porous framework substrate includes carbon, metal, a metal oxide, or a combination thereof. The carbon may be carbon fibers, carbon tubes, or a combination thereof, and the metal may be Ni, Cu, Ti, V, Cr, Mn, Fe, Co, Zn, Mo, W, Ag, Au, Ru, Pt, Ir, Al, Sn, Bi, Si, Sb, stainless steel, an alloy thereof, or a combination thereof. The metal oxide may be an oxide of a metal such as Ru, Sb, Ba, Ga, Ge, Hf, In, La, Ma, Se, Si, Ta, Se, Ti, V, Y, Zn, Zr, or a combination thereof.

For example, the porous framework substrate may have a porosity of about 70% or greater, about 70 to about 99%, about 75to about 99%, about 80 to about 99%, about 85 to about 99%, about 90 to about 99%, or about 95 to about 99%. The porosity is a ratio of the volume occupied by pores to the total volume of the porous framework substrate. As the porous framework substrate has such a high porosity, the lithium-air battery including the cathode has increased energy density. For example, the porous framework substrate has an area resistance of about 100 milliohms·square centimeter (mΩ·cm²) or less, about 80 mΩ·cm² or less, about 60 mΩ·cm² or less, about 40 mΩ·cm² or less, about 30 mΩ·cm² or less, or about 10 mΩ·cm². The porous framework substrate may have a thickness of about 1 to about 500 μm, about 10 to about 450 μm, about 50 to about 350 μm, about 150 to about 300 μm, about 170 to about 230 μm, or about 180 to about 220 μm. When the thickness of the porous framework substrate is within the disclosed ranges, the mechanical strength is excellent, and energy density of the battery may be excellent.

For example, pores included in the porous framework substrate may have a size of about 10 nm to about 50 μm, about 10 nm to about 20 μm, about 100 nm to about 10 μm, about 500 nm to about 10 μm, or about 1 to about 10 μm.

The size of the pores refers to the average diameter of the pores. The average diameter of the pores may be measured by, for example, a nitrogen adsorption method. Alternatively, the average diameter of the pores may be the arithmetic mean of the sizes of the pores measured automatically or manually by software from, for example, a scanning electron microscope image. By the inclusion of the pores within the disclosed ranges, the porous framework substrate may provide a high specific surface area. As a result, the area of the reaction site in which the electrode reaction takes place in the cathode is increased, so that a high rate characteristics of the lithium-air battery including the cathode may be improved.

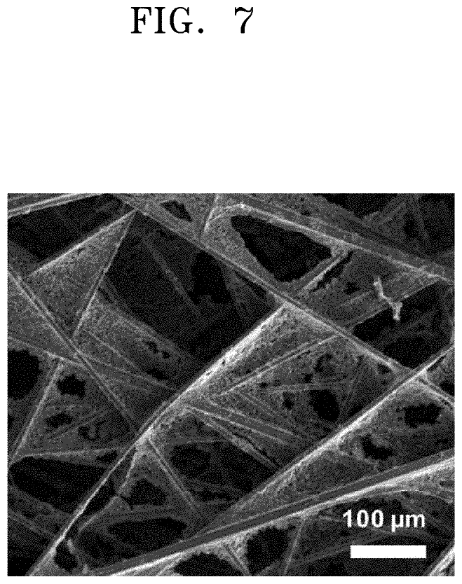

The framework constituting the porous framework substrate includes, for example, a fibrous framework. For example, the fibrous framework may be as shown in FIG. 7. FIG. 7 shows an electron scanning microscope image showing a fibrous skeleton constituting a porous skeleton substrate according to an embodiment.

The fibrous framework may have an average diameter of, for example, about 0.1 to about 10 μm, about 1 to about 10 μm, about 4 to about 10 μm, or about 6 to about 8 μm. By having the fibrous skeleton having a diameter within the disclosed ranges, the cycle characteristics of the lithium-air battery may be further improved. The average diameter of the fibrous skeleton may be measured by analyzing scanning electron microscope images.

The coating layer containing the cathode material according to an embodiment may have a thickness of about 50 nm to about 10 μm or about 1 to about 5 μm.

According to an embodiment, for example, the cathode may substantially consist of the cathode material. As the cathode is formed substantially as a porous film including the cathode material, the structure of the cathode is simplified, and manufacturing the same is also simplified. The cathode is permeable to gas, for example, moisture, oxygen, air, and the like. Accordingly, the cathode is distinguished from a cathode that is substantially impermeable to gas such as moisture, oxygen, and the like. As the cathode is porous, gas-permeable, or a combination hereof, moisture, oxygen, air, and the like may diffuse into the cathode, and thus an electrochemical reaction by lithium ions, electrons, oxygen, and moisture is facilitated at the cathode surface.

In an embodiment, the cathode may include a porous film, and the porous film may include a conductive material. The porous film may further include a coating layer at the surface thereof, and the coating layer may include the cathode material. In an embodiment, the coating layer includes the cathode material. Thus, the cathode not only is distinguished from cathodes that are substantially impermeable to gas such as moisture, oxygen, and the like, but the cathode is also porous, gas-permeable, or a combination thereof and thus facilitates diffusion of moisture, oxygen, air, and the like into the cathode. As lithium ions, electrons, or a combination thereof move through the porous film to facilitate an electrochemical reaction by lithium ions and electrons at the cathode surface, the coating layer of the cathode material also may prevent a discharge product from deteriorate the cathode, and thus the lithium air battery including the cathode may have a long lifespan.

The conductive material may be any suitable material having porosity, conductivity, or a combination thereof, and, for example, may be a carbonaceous material having porosity. The carbonaceous material may be, for example, carbon black, graphite, graphene, activated carbon, carbon fibers, or the like. However, embodiments are not limited thereto, and any suitable carbonaceous material may be used. The conductive material may be, for example, a metallic material. For example, the metallic material may be metal fibers, metal mesh, metal powder, or the like. The metal powder may be, for example, copper, silver, nickel, aluminum, or a combination thereof in powder form. The conductive material may be, for example, an organic conductive material. The organic conductive material may be, for example, polyphenylene derivatives, polythiophene derivatives, or the like. For example, the conductive materials may be used alone or in a combination thereof. The cathode according to an embodiment may include a composite conductor as a conductive material. The cathode according to an embodiment may further include any suitable conductive materials, in addition to the composite conductor.

For example, the cathode may further include a catalyst for oxidation/reduction of oxygen. Examples of the catalyst may include: precious metal-based catalysts such as platinum, gold, silver, palladium, ruthenium, rhodium, and osmium; oxide-based catalysts such as manganese oxide, iron oxide, cobalt oxide, and nickel oxide; and an organic metal-based catalyst such as cobalt phthalocyanine. However, embodiments are not limited thereto. Any suitable catalyst for oxidation/reduction of oxygen used in the art may be used.

For example, the catalyst may be supported on a catalyst support. The catalyst support may be, for example, an oxide support, a zeolite support, a clay-based mineral support, a carbon support, or the like. For example, the oxide support may be a metal oxide support including a metal such as aluminum (Al), silicon (Si), zirconium (Zr), titanium (Ti), cerium (Ce), praseodymium (Pr), samarium (Sm), europium (Eu), terbium (Tb), thulium (Tm), ytterbium (Yb), antimony (Sb), bismuth (Bi), vanadium (V), chromium (Cr), manganese (Mn), iron (Fe), cobalt (Co), nickel (Ni), copper (Cu), niobium (Nb), molybdenum (Mo), and tungsten (W), or a combination thereof. Examples of the oxide support may include alumina, silica, zirconium oxide, titanium dioxide, and the like. Examples of the carbon support may include a carbon black such as Ketjen black, acetylene black, channel black, lamp black, or a combination thereof; a graphite such as natural graphite, artificial graphite, expandable graphite, or a combination thereof; an activated carbon; carbon fibers, or a combination thereof. However, embodiments are not limited thereto. Any suitable catalyst support may be used.

For example, the cathode may further include a binder. For example, the binder may include a thermoplastic resin or a thermocurable resin. For example, the binder may be polyethylene, polypropylene, polytetrafluoroethylene (“PTFE”), polyvinylidene fluoride (“PVdF”), styrene-butadiene rubber, a tetrafluoroethylene-perfluoroalkyl vinyl ether copolymer, a vinylidene fluoride-hexafluoropropylene copolymer, a vinylidene fluoride-chlorotrifluoroethylene copolymer, an ethylene-tetrafluoroethylene copolymer, polychlorotrifluoroethylene, a vinylidene fluoride-pentafluoropropylene copolymer, a propylene-tetrafluoroethylene copolymer, an ethylene-chlorotrifluoroethylene copolymer, a vinylidene fluoride-hexafluoropropylene-tetrafluoroethylene copolymer, a vinylidene fluoride-perfluoromethyl vinyl ether-tetrafluoroethylene copolymer, or an ethylene-acrylic acid copolymer, which may be used alone or in a combination thereof. However, embodiments are not limited thereto. Any suitable binder may be used.

For example, the cathode may be manufactured by mixing a conductive material, a catalyst for oxidation/reduction of oxygen, and a binder together and adding an appropriate solvent thereto to prepare a cathode slurry, and thereafter coating and drying the cathode slurry on a surface of a substrate, or optionally press-molding a dried product to improve electrode density. For example, the substrate may be a cathode current collector, a separator, or a solid electrolyte membrane. The cathode current collector may be, for example, a gas diffusion layer. For example, the conductive material may include a composite conductor. For example, the catalyst for oxidation/reduction of oxygen and the binder may be omitted according to a desired type of the cathode.

The lithium air battery may include an anode including lithium. The lithium air battery may be of an all-solid-state battery type.

The anode may be, for example, a lithium metal thin film, a lithium-based alloy thin film, or a combination thereof. The lithium-based alloy may be, for example, a lithium alloy with, for example, aluminum, tin, magnesium, indium, calcium, titanium, vanadium, or a combination thereof.

The lithium-air battery includes an electrolyte layer disposed between the cathode and the anode.

The electrolyte layer includes an electrolyte such as a solid electrolyte, a gel electrolyte, a liquid electrolyte, or a combination thereof. The solid electrolyte, gel electrolyte, and liquid electrolyte are not specifically limited. Any suitable electrolyte may be used.

The solid electrolyte may include a solid electrolyte including an ionically conducting inorganic material, a solid electrolyte including a polymeric ionic liquid (“PIL”) and a lithium salt, a solid electrolyte including an ionically conducting polymer and a lithium salt, a solid electrolyte including an electronically conducting polymer, or a combination thereof. However, embodiments are not limited thereto. Any suitable solid electrolyte may be used.

For example, the ionically conducting inorganic material may include a glass or amorphous metal ion conductor, a ceramic active metal ion conductor, a glass ceramic active metal ion conductor, or a combination thereof. However, embodiments are not limited thereto. Any suitable ionically conducting inorganic material may be used. For example, the ionically conducting inorganic material may be ionically conducting inorganic particles or a molding product thereof, for example, in sheet form.

For example, the ionically conducting inorganic material may be BaTiO₃, Pb(ZrₐTi₁₋ₐ)O₃ (“PZT”) (wherein 0≤a≤1), Pb₁₋ₓLaₓZr_{1-y}Ti_{y}O₃ (“PLZT”) (wherein 0≤x<1 and 0≤y<1), Pb(Mg_{1/3}Nb_{2/3})O₃—PbTiO₃ (“PMN-PT”), HfO₂, SrTiO₃, SnO₂, CeO₂, Na₂O, MgO, NiO, CaO, BaO, ZnO, ZrO₂, Y₂O₃, Al₂O₃, TiO₂, SiO₂, SiC, lithium phosphate (Li₃PO₄), lithium titanium phosphate (LiₓTi_{y}(PO₄)₃ (wherein 0<x<2 and 0<y<3), lithium aluminum titanium phosphate (LiₓAl_{y}Ti_{z}(PO₄)₃) (wherein 0<x<2, 0<y<1, and 0<z<3), Li_{1+x+y}(AlₐGa₁₋ₐ)ₓ(TibGe_{1-b})₂₋ₓSi_{y}P_{3-y}O₁₂ (wherein 0≤a≤1, 0≤b≤1, 0≤x≤1, and 0≤y≤1), lithium lanthanum titanate (LiₓLa_{y}TiO₃, wherein 0<x<2 and 0<y<3), lithium germanium thio phosphate (LiₓGe_{y}P_{z}S_{w}, wherein 0<x<4, 0<y<1, 0<z<1, and 0<w<5), lithium nitride (LiₓN_{y}, wherein 0<x<4 and 0<y<2), SiS₂-based glass (LiₓSi_{y}S_{z}) (wherein 0<x<3, 0<y<2, and 0<z<4), P₂S₅-based glass (LiₓP_{y}S_{z}) (wherein 0<x<3, 0<y<3, and 0<z<7), Li₂O-based, LiF-based, LiOH-based, Li₂CO₃-based, LiAlO₂-based, or Li₂O—Al₂O₃—SiO₂—P₂O₅—TiO₂—GeO₂-based ceramics, Garnet-based ceramics (Li₃₊ₓLa₃M₂O₁₂) (wherein M is Te, Nb, or Zr)), or a combination thereof.

For example, the PIL may include repeating units containing: i) an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, a triazolium-based cation, or a combination thereof; and ii) an anion of BF₄⁻, PF₆⁻, AsF₆⁻, SbF₆⁻, AlCl₄⁻, HSO₄⁻, ClO₄⁻, CH₃SO₃⁻, (CF₃SO₂)₂N⁻, Cl⁻, Br⁻, I⁻, SO₄⁻, CF₃SO₃⁻, CF₃CO₂⁻, (C₂F₅SO₂)₂N⁻, (C₂F₅SO₂)(CF₃SO₂)N⁻, NO₃⁻, Al₂Cl₇⁻, CF₃COO⁻, (CF₃SO₂)₃C⁻, (CF₃CF₂SO₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, (CF₃SO₂)₂N⁻, or a combination thereof. For example, the PIL may be poly(diallyldimethylammonium) bis(trifluoromethanesulfonyl)imide) (“TFSI”)), poly(1-allyl-3-methylimidazolium bis(trifluoromethanesulfonyl)imide), poly((N-methyl-N-propylpiperidinium bis(trifluoromethanesulfonyl)imide, or the like.

The ionically conducting polymer may include, for example, an ion conductive repeating unit such as an ether-based monomer, an acryl-based monomer, a methacryl-based monomer, a siloxane-based monomer, or a combination thereof.

The ionically conducting polymer may include, for example, polyethylene oxide (“PEO”), polyvinyl alcohol (“PVA”), polyvinyl pyrrolidone (“PVP”), polyvinyl sulfone, polypropylene oxide (“PPO”), polymethylmethacrylate, polyethylmethacrylate, polydimethylsiloxane, polyacrylic acid, polymethacrylic acid, poly(methyl acrylate), poly(ethyl acrylate), poly(2-ethylhexyl acrylate), poly(butyl methacrylate), poly(2-ethylhexyl methacrylate), poly(decyl acrylate), polyethylene vinyl acetate, a phosphate ester polymer, polyester sulfide, polyvinylidene fluoride (“PVdF”), or Li-substituted sulfonated tetrafluoroethylene based fluoropolymer-copolymer (Nafion™). However, embodiments are not limited thereto. Any suitable ionically conducting polymer may be used.

The electronically conducting polymer may be, for example, a polyphenylene derivative or a polythiophene derivative. However, embodiments are not limited thereto. Any suitable electronically conducting polymer may be used.

The gel electrolyte may be obtained, for example, by adding a low-molecular weight solvent to a solid electrolyte between the cathode and the anode. The gel electrolyte may be a gel electrolyte obtained by further adding, to a polymer, a low-molecular weight organic compound such as a solvent, an oligomer, or the like. The gel electrolyte may be a gel electrolyte obtained by further adding, to the disclosed polymer electrolytes, a low-molecular weight organic compound such as a solvent or an oligomer.

The liquid electrolyte may include a solvent and a lithium salt.

The solvent may include an organic solvent, an ionic liquid (“IL”), an oligomer, or a combination thereof. However, embodiments are not limited thereto. Any suitable solvent that is in liquid form at room temperature (25° C.) may be used.

The organic solvent may include, for example, an ether-based solvent, a carbonate-based solvent, an ester-based solvent, a ketone-based solvent, or a combination thereof. For example, the organic solvent may include propylene carbonate, ethylene carbonate, fluoroethylene carbonate, vinylethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxirane, 4-methyldioxorane, dimethyl acetamide, dimethylsulfoxide, dioxane, 1,2-dimethoxyethane, sulfolane, dichloroethane, chlorobenzene, nitrobenzene, succinonitrile, diethylene glycol dimethyl ether (“DEGDME”), tetraethylene glycol dimethyl ether (“TEGDME”), polyethylene glycol dimethyl ether (“PEGDME”, Number average molecular weight (Mn)=about 500), dimethyl ether, diethyl ether, dibutyl ether, dimethoxyethane, 2-methyltetrahydrofuran, tetrahydrofuran, or a combination thereof. However, embodiments are not limited thereto. The organic solvent may be any suitable organic solvent that is in liquid form at room temperature.

The IL may include, for example, i) an ammonium-based cation, a pyrrolidinium-based cation, a pyridinium-based cation, a pyrimidinium-based cation, an imidazolium-based cation, a piperidinium-based cation, a pyrazolium-based cation, an oxazolium-based cation, a pyridazinium-based cation, a phosphonium-based cation, a sulfonium-based cation, triazolium-based cation, or a combination thereof, and ii) an anion of BF₄—, PF₆—, AsF₆—, SbF₆—, AlCl₄—, HSO₄—, ClO₄⁻, CH₃SO₃⁻, CF₃CO₂—, (CF₃SO₂)₂N—, Cl—, Br—, I⁻, SO₄⁻, CF₃SO₃⁻, (C₂F₅SO₂)₂N—, (C₂F₅SO₂)(CF₃SO₂)N—, NO₃⁻, Al₂Cl₇⁻, CH₃COO⁻, CF₃SO₃⁻, (CF₃SO₂)₃C⁻, (CF₃CF₂SO₂)₂N⁻, (CF₃)₂PF₄⁻, (CF₃)₃PF₃⁻, (CF₃)₄PF₂⁻, (CF₃)₅PF⁻, (CF₃)₆P⁻, SF₅CF₂SO₃⁻, SF₅CHFCF₂SO₃⁻, CF₃CF₂(CF₃)₂CO⁻, (CF₃SO₂)₂CH⁻, (SF₅)₃C⁻, (O(CF₃)₂C₂(CF₃)₂O)₂PO⁻, or a combination thereof.

The lithium salt may include LiTFSI, LiPF₆, LiBF₄, LiAsF₆, LiClO₄, LiNO₃, (lithium bis(oxalato) borate (“LiBOB”), LiCF₃SO₃, LiN(SO₂CF₃)₂, LiN(FSO₂)₂, LiN(SO₂C₂F₅)₂, LiC(SO₂CF₃)₃, LiC₄F₉SO₃, LiAlCl₄, LiBOB. However, embodiments are not limited thereto. Any suitable material may be used as a lithium salt. A concentration of the lithium salt may be, for example, about 0.01 to about 5.0 molar (moles per liter (M)).

The solid electrolyte may be, for example, an oxide-based solid electrolyte blocking moisture.

The lithium-air battery may further include a separator between the cathode and the anode. Any suitable separator may be used as long as the separator is durable under operation conditions of the lithium-air battery. For example, the separator may include a polymer non-woven fabric, for example, a non-woven fabric of polypropylene material or a non-woven fabric of polyphenylene sulfide; a porous film of an olefin resin such as polyethylene or polypropylene; or glass fibers. These separators may be used in a combination of at least two thereof.

The electrolyte layer may have a structure in which a solid polymer electrolyte is impregnated in the separator, or a structure in which a liquid electrolyte is impregnated in the separator. For example, the electrolyte layer in which a solid polymer electrolyte is impregnated in the separator may be prepared by arranging solid polymer electrolyte films on opposite surfaces of the separator and thereafter roll-pressing them at the same time. For example, the electrolyte layer in which a liquid electrolyte is impregnated in the separator may be prepared by injecting a liquid electrolyte including a lithium salt into the separator.

The lithium-air battery may be manufactured by installing the anode on an inner side of a case, sequentially arranging the electrolyte layer on the anode, the cathode on the electrolyte layer, and a porous cathode current collector on the cathode, and then arranging a pressing member on the porous cathode current collector and pressing a resulting cell structure with the pressing member to allow air including moisture and oxygen to reach to the air electrode. The case may be divided into upper and lower portions which contact the anode and the air electrode, respectively. An insulating resin may be disposed between the upper and lower portions of the case to electrically insulate the cathode and the anode from one another.

The lithium-air battery according to an embodiment may be used as a primary battery or a secondary battery. The shape of the lithium-air battery is not specifically limited and, for example, the lithium-air battery may have a shape of a coin, a button, a sheet, a stack, a cylinder, a plane, or a horn. The lithium-air battery may be used in a medium-and-large size battery for electric vehicles.

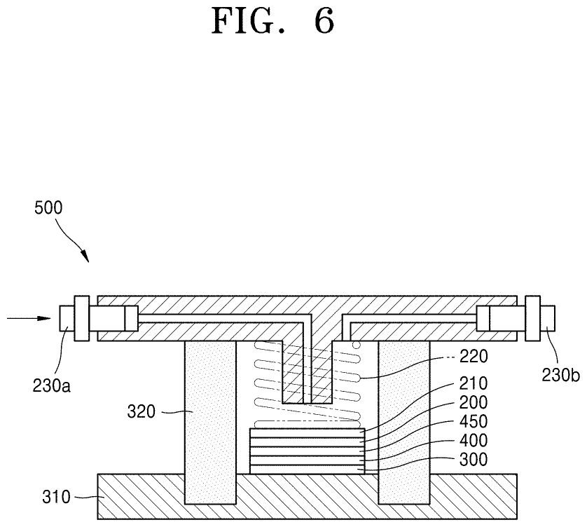

A lithium-air battery according to an embodiment is schematically presented in FIG. 6.

Referring to FIG. 6, a lithium-air battery 500 according to an embodiment includes: a cathode 200 adjacent to a first current collector 210 and configured to use air including water as a cathode active material; an anode 300 adjacent to a second current collector 310 and including lithium; and a first electrolyte layer 400 between the cathode 200 and the anode 300. The first electrolyte layer 400 is a liquid electrolyte-impregnated separator. A second electrolyte layer 450 is arranged between the cathode 200 and the first electrolyte layer 400. The second electrolyte layer 450 is a lithium ion-conductive solid electrolyte film. The first current collector 210 is porous and may function as a gas diffusion layer allowing the moisture-and-oxygen-including air to diffuse. In an embodiment, a gas diffusion layer may be additionally disposed between the first current collector 210 and the cathode 200. A pressing member 220 is arranged on the first current collector 210 to enable the moisture-and-oxygen-containing air to reach the cathode 200. A case 320 made of an insulating resin material may be disposed between the cathode 200 and the anode 300 to electrically insulate the cathode 200 and the anode 300 from one another. The air is supplied through an air inlet 230a and is discharged through an air outlet 230b. The lithium-air battery 500 may be accommodated in a stainless steel container. The air present in a cavity between the first current collector 210 and the cathode 200 includes moisture and oxygen, wherein the amount of the moisture in the air may be, with respect to 100 parts by weight of the oxygen in the air, 4 parts by weight or less, 0.001 to 4 parts by weight, 1.5 to 4 parts by weight, or 1.5 to 3 parts by weight. Herein, the moisture refers to water vapor.

A method of manufacturing a cathode according to an embodiment includes: providing a suspension including the cathode material according to an embodiment; and depositing, on a porous framework substrate, the metal oxide particles by electrophoresis.

The cathode manufacturing method does not involve a heat treatment, and thus may prevent deterioration occurring during a heat treatment process, and material with weak heat resistance may be used.

The suspension may include a lithium-containing metal oxide, a dispersant, and a solvent.

The type of the dispersant is not specifically limited, and any suitable dispersant may be used. Examples of the dispersant are polyacrylic acid, polyacrylic acid ammonium salt, polymethacrylic acid, polymethacrylic acid ammonium salt, polyacrylic maleic acid, and the like. The amount of the dispersant may be about 0.01 to about 5 parts by weight, with respect to 100 parts by weight of the suspension.

The amount of the cathode material may be about 0.01 to about 10 parts by weight, about 0.01 to about 1 parts by weight, or about 0.05 to about 0.5 parts by weight, with respect to 100 parts by weight of the suspension.

The cathode material may have a particle size of, for example, about 10 to about 500 nm, about 50 to about 450 nm, about 100 to about 400 nm, about 150 to about 350 nm, about 200 to about 350 nm, or about 250 to about 350 nm. When the size of the cathode material is within the disclosed ranges, electrophoretic deposition may be effectively performed without formation of an uneven suspension caused by agglomeration of particles.

The solvent may be alcohols such as ethanol, and N-methyl-2-pyrrolidone (NMP). The amount of the solvent may be appropriately controlled so that each component of the composition may be dissolved or dispersed.

An electrode formed of a porous framework substrate and a counter electrode are placed in a suspension, and a voltage is applied between the electrodes so that metal oxide particles containing lithium are deposited on the porous framework substrate.

The applied voltage may be, for example, about 10 to about 200 volts per centimeter (V/cm), or about 50 to about 100 V/cm. The voltage application time may be, for example, about 1 to about 60 minutes (min), about 1 to about 40 min, about 1 to about 20 min, or about 1 to about 10 min.

The porous framework substrate may be, for example, carbon paper, stainless steel (“SUS”) mesh, Ni mesh, or the like.

For example, the metal oxide particles as a cathode material are coated along the surface of fibrous carbon of carbon paper. That is, a conformal coating layer of the lithium-containing metal oxide is obtained.

The porous framework substrate of which the surface is deposited with the metal oxide particles, which are a cathode material, is taken out of the suspension and dried, and accordingly, a cathode is manufactured.

According to an embodiment, the cathode manufacturing method may include: preparing a composition including a cathode material and a binder; molding the composition to prepare a sheet; and heat-treating the sheet in an oxidizing atmosphere at about 450 to about 800° C. When the heat treatment is performed in this temperature range, the binder is removed.

The composition may include, for example, a dispersant, a plasticizer, or the like, in addition to the disclosed cathode material and binder. The types and amounts of the binder, the dispersant, and the plasticizer are not specifically limited. For example, the composition may include, with respect to 100 parts by weight of the cathode material, about 5 to about 20 parts by weight of the binder, about 1 to about 10 parts by weight of the dispersant, and about 1 to about 10 parts by weight of the plasticizer. The composition may further include a solvent. For example, the amount of the solvent may be, about 1 to about 500 parts by weight, with respect to 100 parts by weight of the solid content, including the cathode material, binder, dispersant, plasticizer, and the like.

For example, the molding of the composition to prepare a sheet may include: coating and drying the composition on a substrate to prepare a coating layer; and stacking and laminating a plurality of coating layers to prepare a sheet.

The composition may be coated on a substrate such as a release film by using a doctor blade to a thickness of about 1 to about 1,000 μm, and thereafter dried to prepare a coating layer.

A green sheet may be prepared by preparing a plurality of coating layers, each arranged on a release film, stacking the coating layers to oppose each other, and laminating the coating layers. Laminating may be performed by hot rolling at a constant pressure.

The prepared green sheet may be heat-treated in an oxidizing atmosphere at about 500 to about 700° C. for about 1 to about 4 hours and then in an oxidizing atmosphere at about 900 to about 1,300° C. for about 3 to about 10 hours.

Through the heat treatment performed in the oxidizing atmosphere at about 500 to about 700° C. for about 1 to about 4 hours, organic substances and the like in the green sheet are stably decomposed and removed, and through the heat treatment in the oxidizing atmosphere at about 900 to about 1,300° C. for about 3 to about 10 hours, the cathode material powder is sintered so that a stable, durable porous film is prepared. During the heat treatment, the rate of increasing temperature to a heat treatment temperature is, for example, about 5 degrees Celsius per minute, and cooling may be natural cooling.

One or more embodiments of the disclosure will now be described in detail with reference to the following examples. However, these examples are only for illustrative purposes and are not intended to limit the scope of the one or more embodiments of the disclosure.

### EXAMPLES

### Manufacture of Cathode

### Example 1

Ti₂O₃ was ground in a ball mill to obtain powder having an average diameter of 100 nm. The powder had a density of 4.524 grams per cubic centimeter (g/cm³) and a trigonal crystal structure. Ti₂O₃ powder, and polyacrylic acid (weight average molecular weight 1,800 Dalton) as a dispersant were added to ethanol and stirred to prepare a suspension. The amount of Ti₂O₃ was 0.1 weight percent (wt %), and the amount of the dispersant was 0.05 wt %.

Carbon paper (SGL Ltd., 29BA) was used for an anode and a cathode in the suspension. The used carbon paper had a thickness of about 190 μm, a porosity of about 89%, and an area resistance (through-plane resistance) of less than 10 milliohms per cubic centimeter (mΩ·cm⁻³).

The fibrous carbon included in the carbon paper had an average diameter of about 7 μm. A voltage of 100 volts per centimeter (V/cm) was applied across the cathode and the anode for 10 minutes to deposit Ti₂O₃ on the carbon paper by electrophoretic deposition.

A loading level of the deposited lithium-containing metal oxide coating layer was 6 milligrams per square centimeter (mg/cm²), and the coating layer had a thickness of 4 μm. The carbon paper on which the lithium-containing metal oxide was deposited was taken out of the suspension and dried at 25° C. for 2 hours to manufacture a cathode. The cathode had a porosity of about 89%.

### Example 2 to Example 7

The cathodes were manufactured in the same manner as in Example 1, except that instead of Ti₂O₃, the cathode materials of Table 1 were used, respectively.

TABLE 1

| Example | Cathode material |
|---|---|
| Example 1 | Ti₂O₃ |
| Example 2 | CuO |
| Example 3 | Ce₁₇O₃₂ |
| Example 4 | Fe₃O₄ |
| Example 5 | Eu₂O₃ |
| Example 6 | Eu₃O₄ |
| Example 7 | Co₃O₄ |

### Comparative Example 1

Li₂CO₃, La₂O₃, and RuO₂ powder were added to ethanol according to the composition ratio of Li_{0.34}La_{0.55}RuO₃ and mixed. The amount of ethanol was about 4 parts by weight, with respect to 100 parts by weight of the total weight of Li₂CO₃, La₂O₃, and RuO₂ powder.

The mixture was put in a ball-milling apparatus and ground and mixed for 4 hours. The mixed product was dried and thereafter heated to 800° C. at a temperature increase rate of 5° C./minutes (min), and first heat-treated at this temperature under air atmosphere for 4 hours.

The powder obtained through the first heat treatment was ground to prepare powder including primary particles having a size of about 0.3 μm. The prepared powder was pressed to form cylindrical pallets each having a diameter of about 1.3 centimeters (cm), a height of about 0.5 cm, and a weight of about 0.3 grams (g). The prepared pellets were secondarily heat-treated under air atmosphere at a temperature of 1,200° C. for about 24 hours to obtain a target product. For the secondary heat treatment, the temperature was increased to 1,200° C. at a temperature increase rate of about 5° C./min.

A cathode was manufactured from the prepared Li_{0.34}La_{0.55}RuO₃ in the same manner as in Example 1.

### Manufacture of Lithium Air Battery

### Manufacturing Example 1

A separator (Celgard 3501) was disposed on a lithium metal foil anode.

0.2 milliliters (mL) of an electrolyte solution of 1 molar (moles per liter (M)) lithium bis(trifluoromethanesulfonyl)imide (“LiTFSI”) dissolved in propylene carbonate (“PC”) was injected to the separator to prepare an anode intermediate layer.

On the separator, a lithium-aluminum titanium phosphate (“LATP”) solid electrolyte (Thickness: 250 μm, Ohara Corp., Japan) was disposed to prepare a lower structure consisting of the anode/anode intermediate layer/solid electrolyte.

The lower structure was coated with an aluminum-coated pouch. A window of a certain size was formed on the upper surface of the pouch to externally expose the LATP solid electrolyte.

The cathode manufactured in Example 1 was disposed on the externally exposed LATP solid electrolyte. Subsequently, a gas diffusion layer (“GDL”) (SGL Ltd., 25BC) was disposed on the upper surface of the cathode, a nickel mesh was disposed on the gas diffusion layer, air under a humid condition, i.e., air containing moisture and oxygen was filled between the cathode and the gas diffusion layer, and thereafter a pressing member, which enables the air to be transferred to the cathode, was placed on the nickel mesh and pressed to fix a cell, thereby manufacturing a lithium-air battery. The humid condition contained 4 wt % of water vapor relative to the total air.

### Manufacturing Examples 2 to 7

Lithium-air batteries were manufactured in the same manner as in Manufacturing Example 1, except that, instead of the cathode manufactured in Example 1, the cathodes of Examples 2 to 7 were used, respectively.

### Comparative Manufacturing Example 1

Lithium-air battery was manufactured in the same manner as in Manufacturing Example 1, except that, instead of the cathode manufactured in Example 1, the cathode manufactured in Comparative Example 1 were manufactured.

### Evaluation Example 1

### Electron Scanning Microscopy

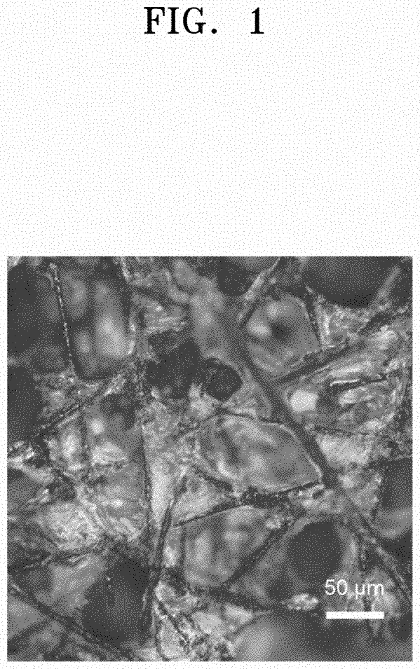

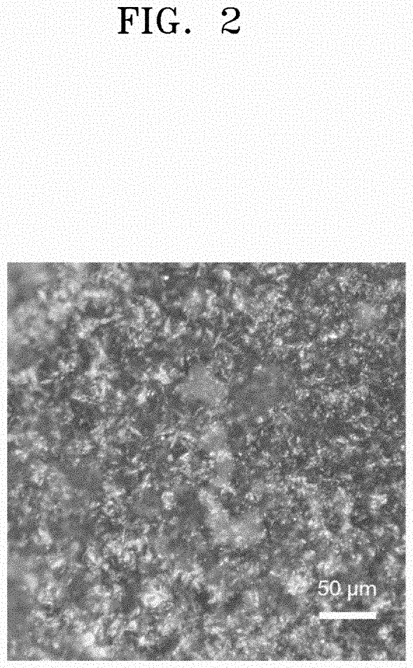

A surface (A) of the cathode of the lithium-air battery 1, adjacent to the solid electrolyte, and the other surface (B) of the cathode were observed using electron scanning microscopy. FIGS. 1 and 2 are images of the surface (B) of the cathode, and the surface (A) of the cathode adjacent to the solid electrolyte, respectively.

As shown in FIG. 1, it is found that the metal oxide coating layer, as the cathode material, was uniformly arranged well along the fibrous carbons of the carbon paper, which is a porous support, and it is found from FIG. 2 that the metal oxide-containing coating layer was formed.

### Evaluation Example 2

### Evaluation of Moisture Stability Against Strong Base

With each of the cathodes manufactured in Examples 1 and 2 and Comparative Example 1 as a working electrode, and a Pt electrode as a counter electrode, a voltage of 2.8 volts (V) or 4.3 V was applied across the cathode and the counter electrode in a 1 M LiOH aqueous solution for 10 minutes and thereafter, metals, other than Li ions, dissolved in the aqueous solution were analyzed using inductively coupled plasma (“ICP”) analysis. The results are shown in Table 2.

TABLE 2

| | | | Dissolved amount |
|---|---|---|---|
| | | | (milligrams per |
| Example | Voltage (V) | Analyzed metal | liter (mg/L)) |
| Comparative | 2.8 | Ru | 0.81 |
| Example 1 | 4.3 | | 0.81 |
| Example 1 | 2.8 | Ti | 0 |
| | 4.3 | | 0 |
| Example 2 | 2.8 | Cu | 0.8 |
| | 4.3 | | 0.8 |

As shown in Table 2, as a result of the ICP measurement for confirming the dissolution of transition metals, it was found that the Ru-based oxide of Comparative Example 1 was dissolved out in a strong basic aqueous solution (for example, a lithium aqueous solution), whereas the cathodes containing the cathode materials of Examples 1 and 2 were not dissolved in the strong base at 2.8 V or 4.3 V. That is, the cathode materials used in Examples 1 and 2 were found stable in a strong base.

The cathodes manufactured in Example 1, Example 2, and Comparative Example 1 were analyzed by cyclic voltammetry. As a result of the analysis, no change in color of the electrolyte solution was visible with the naked eye.

### Evaluation Example 3

### Phase Stability, Bandgap Energy, and Lithium Insertion Voltage

Phase stability was evaluated under the conditions of pH of 12 to 14 and a voltage of 2.5 to 4 V by establishing a quantum calculation-based Pourbaix diagram and a phase stability calculation platform, screening, and examining the difference in energy between the most stable material and a test material. By this evaluation method, a cathode material having a change in Gibbs free energy value (ΔG) of 0 electronvolts (eV) was derived under the conditions of pH of 12 to 14 and a voltage of 2 to 4.5 V.

Bandgap energy was obtained by the first-principles electronic structure calculation method based on the density functional theory (“DFT”). Lithium insertion voltage was determined by DFT calculation.

The results of evaluation of the phase stability, bandgap energy, and lithium insertion voltage are shown in Table 2. For characteristics comparison with the cathode materials of Examples 1 to 7, those of HfO₂, Ta₂O₅, and Mn₂O₃ are also shown in Table 3.

TABLE 3

| | Cathode | Phase stability | Bandgap | Lithium insertion |
|---|---|---|---|---|
| Example | material | value (eV) | energy (eV) | voltage (V) |
| Example 1 | Ti₂O₃ | 0.39 | 0 | 1.32 |
| Example 2 | CuO | 0.25 | 0 | 2.41 |
| Example 3 | Ce₁₇O₃₂ | 0.34 | 0 | 1.18 |
| Example 4 | Fe₃O₄ | 0.34 | 0 | 2.14 |
| Example 5 | Eu₂O₃ | 0.00 | 0 | 1.86 |
| Example 6 | Eu₃O₄ | 0.27 | 0 | 1.75 |
| Example 7 | Co₃O₄ | 0.76 | 0 | 2.56 |
| Reference | HfO₂ | 0.00 | 3.39 | 0.46 |
| Example 1 | | | | |
| Reference | Ta₂O₅ | 0.00 | 3.30 | 1.70 |
| Example 2 | | | | |
| Reference | Mn₂O₃ | 1.24 | 0.00 | 2.87 |
| Example 3 | | | | |

As shown in Table 3, the cathode materials of Examples 1 to 7 exhibited a phase stability value of 0 to 0.34 eV, a bandgap energy of 0 eV, and a lithium insertion voltage of 2.41 eV or less.

HfO₂ of Reference Example 1 and Ta₂O₅ of Reference Example 2 exhibited a bandgap energy of 3.39 eV, and Mn₂O₃ of Reference Example 3 exhibited a lithium insertion voltage greater than 2.5 eV. From this, it was found that the cathode materials of Reference Examples 1 to 3 were not suitable as cathode materials according to an embodiment.

### Evaluation Example 4

### Lithium-Air Battery Evaluation

The lithium-air batteries manufactured in Manufacturing Example 1 and Comparative Manufacturing Example 1 were subjected once to a charging/discharging cycle of discharging at 40° C., 1 atmosphere (atm), and under oxygen atmosphere containing 4 wt % of water vapor with a constant current of 0.3 milliamperes per square centimeter (mA/cm²) to 2.0 V (vs. Li) and thereafter charging with the same current to 4.5 V. Charging and discharging were cut-off at a charge/discharge capacity of 3 mAh/cm².

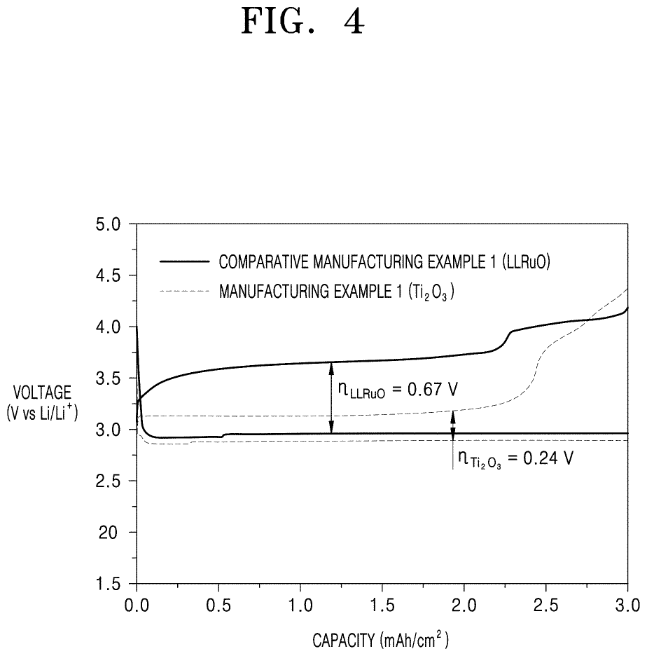

As shown in FIG. 4, a difference between charging voltage and discharging voltage at a cut-off was about 0.24 V in the lithium-air battery manufactured in Manufacturing Example 1, but was about 0.67 V in the lithium-air battery of Comparative Manufacturing Example 1.

Accordingly, the lithium-air battery of Manufacturing Example 1 was found to have a reduced charging/discharging overvoltage, compared to the lithium-air battery of Comparative Manufacturing Example 1, due to improved reversibility of the production/extinction reaction of the discharge product. When the charging overvoltage is reduced during charging, the battery may have an increased charging/discharging efficiency.

### Evaluation Example 5

### Infrared (“IR”) Analysis of Cathode Material After Charging and Discharging of Lithium-Air Battery

The lithium-air battery manufactured in Manufacturing Example 1 was subjected once to a charging/discharging cycle of discharging at 40° C., 1 atm, and under oxygen atmosphere containing 4 wt % of water vapor with a constant current of 0.3 mA/cm² (0.1 C) to 2.0 V (vs. Li) and thereafter charging with the same current to 4.5 V. Charging and discharging were cut-off at a charge/discharge capacity of 3 mAh/cm².

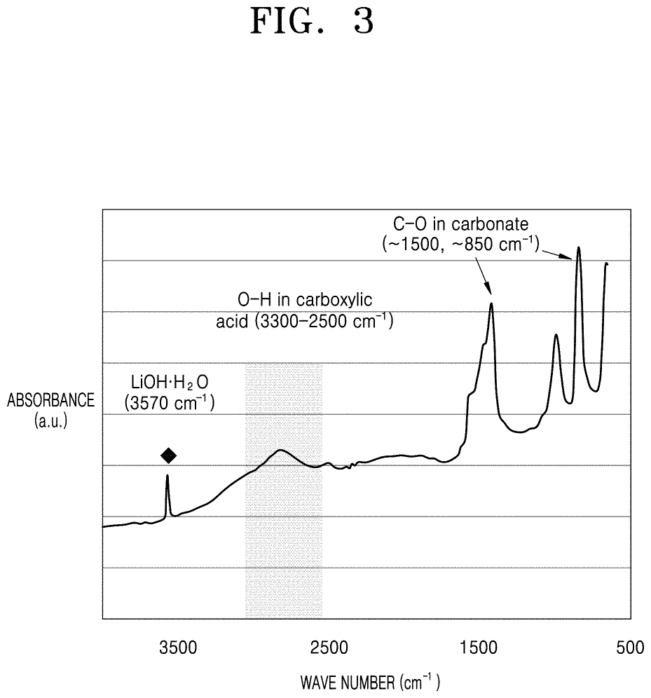

IR spectra of the cathode material of Manufacturing Example 1 were measured and shown in FIG. 3.

Referring to FIG. 3, it was found from an absorption peak of 3,570 cm⁻¹ that the discharge product was LiOH. Thus, it was found that a lithium hydroxide-based cathode reaction occurred.

### Evaluation Example 6

### X-Ray Diffraction (“XRD”) Analysis

The lithium-air battery manufactured in Manufacturing Example 1 was subjected once to a charging/discharging cycle of discharging at 40° C., 1 atm, and under oxygen atmosphere containing 4 wt % of water vapor with a constant current of 0.3 mA/cm² (0.1 C) to 2.0 V (vs. Li) and thereafter charging with the same current to 4.5 V. Charging and discharging were cut-off at a charge/discharge capacity of 3 mAh/cm².

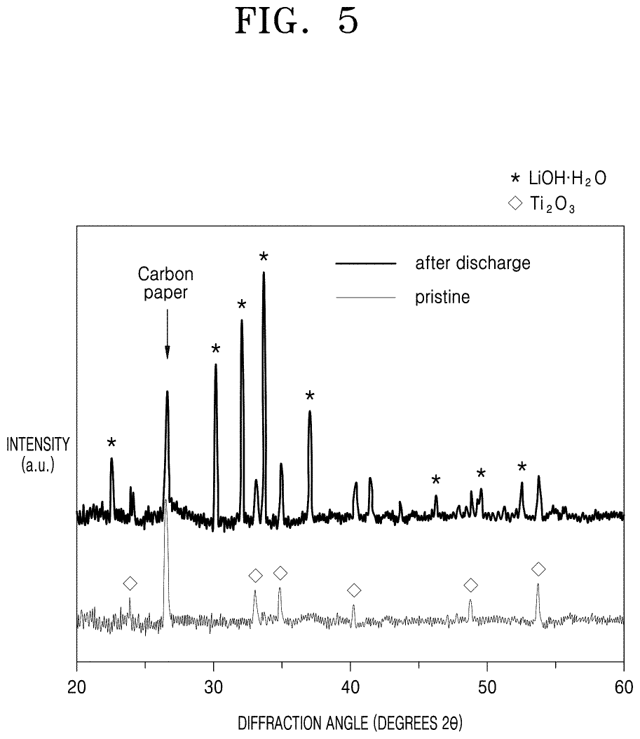

XRD spectra of the cathode material included in the cathode were measured and shown in FIG. 5. In FIG. 5, “pristine” and “after discharge” indicates the states before and after charging, respectively. The XRD spectrum measurement was performed with Cu Kα radiation.

Referring to FIG. 5, characteristic peaks of hydrated lithium hydroxide appeared at a 2θ region of 21.4°, 30.1°, 33.6°, and 36.9°, indicating that a LiOH production reaction occurred. The hydrated lithium hydroxide in the cathode was observed as a discharge product. Thus, it was found that the lithium hydroxide-based cathode reaction occurred.

Thus, the lithium-air battery of the cathode of Manufacturing Example 1 exhibited no crystalline change in the cathode material even after 10 times of the charging/discharging cycle, and thus found to have structural stability.

### Evaluation Example 7

### Electronic Conductivity Evaluation

Au was sputtered on both surfaces of each of the cathodes manufactured in Examples 1 and 2 and Comparative Example 1 to complete an ion-blocking cell. The ionic conductivity at 25° C. was measured using a direct-current (“DC”) polarization method.

The time dependent current obtained when a constant voltage of 100 millivolts (mV) is applied to the completed symmetric cell for 30 minutes was measured. The electronic resistance of the composite conductor was calculated from the measured current, and electronic conductivity was calculated therefrom.

The cathode materials of Examples 1 and 2 were found to have improved electronic conductivity, as compared with the electronic conductivity (5.6×10⁻² siemens per centimeter (S/cm)) of the cathode material of Comparative Example 1.

The cathode material according to an embodiment has improved stability against moisture and excellent electronic conductivity. Using such a cathode material, a cathode with improved durability may be manufactured. Using this cathode, a lithium-air battery with good charge/discharge characteristics may be manufactured.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A cathode material configured to use water and oxygen as a cathode active material, the cathode material comprising:
a metal oxide represented by Formula 1:
MₓO_{y} Formula 1
wherein, in Formula 1, M is Ti, Cu, Co, Ce, Cu, Fe, Eu, Cd, Co, Cr, Mn, Mo, Nb, Pu, Ru, Tc, U, V, Ir, or a combination thereof, 0<x≤20, 0<y≤34, and 0.05<y/x<10,
with the proviso that when M is Mn, 0.05<y/x≤1.4,
wherein the cathode material has
a phase stability value of about 1.2 electronvolts or less at a pH of 12 to 14 and at a voltage of 2 to 4.5 volts with respect to lithium metal, and
a bandgap energy of 0 electronvolts when determined by density functional theory.

2. The cathode material of claim 1, wherein the cathode material has a lithium insertion voltage of greater than 0 to about 2.5 volts.

3. The cathode material of claim 1, wherein 0.1<y/x<4.

4. The cathode material of claim 1, wherein the cathode material has an energy above hull of less than about 0.1 electronvolts, and the amount of change in the Gibbs free energy value at a voltage of 2 to 4.5 volts is 0 electronvolts.

5. The cathode material of claim 1, wherein the cathode material has a phase stability value of 0 to 0.5 electronvolts.

6. The cathode material of claim 1, wherein, in Formula 1, 1≤x≤17 and 1≤y≤32.

7. The cathode material of claim 1, wherein, in Formula 1, M is Ti, Cu, Co, Ce, Cu, Fe, Eu, or a combination thereof, and 1≤y/x≤3.

8. The cathode material of claim 1, wherein, in Formula 1, 0.5<y/x<2.5.

9. The cathode material of claim 1, wherein the cathode material is a metal oxide represented by Formulae 2 to 6:
TiₓO_{y} Formula 2
wherein, in Formula 2, 1≤y/x≤2,
CuₓO_{y} Formula 3
wherein, in Formula 3, 0.5≤y/x≤2,
CeₓO_{y} Formula 4
wherein, in Formula 4, 1≤y/x≤2,
FeₓO_{y} Formula 5
wherein, in Formula 5, 1≤y/x≤2,
EuₓO_{y} Formula 6
wherein, in Formula 6, 1≤y/x≤2, or
a combination thereof.

10. The cathode material of claim 9, wherein, in Formulae 2 to 6, 1≤x≤17 and 1≤y≤32.

11. The cathode material of claim 1, wherein the cathode material is Ti₁₁O₁₈, Ti₁₃O₂₂, Ti₁₉O₃₀, Ti₂O₃, Ti₃O₅, Ti₄O₇, Ti₅O₈, Ti₅O₉, Ti₆O₁₁, Ti₇O₁₃, Ti₈O₁₅, Ti₉O₁₇, Ti₁₀O₁₈, Ti₁₃O₂₂, Ti₁₉O₃₀, CdO, Ce₁₃O₂₄, Ce₁₆O₂₇, Ce₁₇O₃₂, Ce₅O₉, Ce₇O₁₂, CoO, CrO, Cu₄O₃, Cu₈O₇, CuO, Eu₂O₃, Eu₃O₄, EuO, Fe₁₂O₁₃, Fe₃O₄, Fe₇O₈, FeO, IrO₂, MnO, MoO₂, Nb₁₂O₂₉, RuO₂, TcO₂, V₂O₃, or a combination thereof.

12. The cathode material of claim 1, wherein an amount of the water in the cathode active material is greater than 0 to about 4 parts by weight, with respect to 100 parts by weight of the oxygen.

13. The cathode material of claim 1, wherein the cathode material has an electronic conductivity at 25° C. of about 1.0×10⁻⁶ to about 100 siemens per centimeter.

14. A cathode comprising the cathode material of claim 1.

15. The cathode of claim 14, wherein an amount of the cathode material in the cathode is about 1 to about 100 parts by weight, with respect to 100 parts by weight of a total weight of the cathode.

16. A lithium-air battery comprising:
a cathode comprising the cathode material of claim 1;
an anode comprising lithium; and
an electrolyte disposed between the cathode and the anode.

17. The lithium-air battery of claim 16, wherein the electrolyte is an oxide solid electrolyte, and
the oxide solid electrolyte is Li_{1+x+y}AlₓTi₂₋ₓSi_{y}P_{3-y}O₁₂ wherein 0<x<2 and 0≤y<3, BaTiO₃, Pb(ZrₐTi₁₋ₐ)O₃ wherein 0≤a≤1, Pb₁₋ₓLaₓZr_{1-y}Ti_{y}O₃ wherein 0≤x<1 and 0≤y<1, Pb(Mg_{1/3}Nb_{2/3})O₃—PbTiO₃, HfO₂, SrTiO₃, SnO₂, CeO₂, Na₂O, MgO, NiO, CaO, BaO, ZnO, ZrO₂, Y₂O₃, Al₂O₃, TiO₂, SiO₂, Li₃PO₄, LiₓTi_{y}(PO₄)₃ wherein 0<x<2 and 0<y<3, LiₓAl_{y}Ti_{z}(PO₄)₃ wherein 0<x<2, 0<y<1, and 0<z<3, Li_{1+x+y}(AlₐGa₁₋ₐ)ₓ(Ti_{b}Ge_{1-b})₂₋ₓSi_{y}P_{3-y}O₁₂ wherein 0≤a≤1, 0≤b≤1, 0≤x≤1, and 0≤y≤1, LiₓLa_{y}TiO₃ wherein 0<x<2 and 0<y<3, Li₂O, LiOH, Li₂CO₃, LiAlO₂, Li₂O—Al₂O₃—SiO₂—P₂O₅—TiO₂—GeO₂, Li₃₊ₓLa₃M₂O₁₂ wherein M is Te, Nb, or Zr, and x is an integer from 1 to 10, or a combination thereof.

18. The lithium-air battery of claim 16, wherein the electrolyte is Li₇La₃Zr₂O₁₂, Li₃₊ₓLa₃Zr₂₋ₐMₐO₁₂, wherein M is Ga, W, Nb, Ta, or Al, x is an integer from 1 to 10, and 0.05≤a≤0.7, or combination thereof.

19. The lithium-air battery of claim 17, wherein the cathode comprises a porous framework substrate and a coating layer disposed on the porous framework substrate, and the coating layer comprises the cathode material.

20. A method of manufacturing a cathode, the method comprising:
providing a suspension comprising the cathode material of claim 1; and
depositing the cathode material on a porous framework substrate by electrophoresis.

21. A lithium-air battery, comprising:
a cathode comprising
a porous framework substrate having a porosity of about 70 to about 99%, and
Ti₂O₃, CuO, Ce₁₇O₃₂, Fe₃O₄, Eu₂O₃, Eu₃O₄, or Co₃O₄ having a particle size of about 10 to about 500 nanometers and disposed on the porous framework substrate;
an anode comprising lithium; and
a lithium aluminum titanium phosphate solid electrolyte between the cathode and the anode.
